(19) United States
(12) Patent Application Publication
(10) Pub. No.: US 2015/0348473 A1
(43) Pub. Date: Dec. 3, 2015

(54) SYSTEMS, DEVICES, AND METHODS FOR DRIVING AN ANALOG INTERFEROMETRIC MODULATOR UTILIZING DC COMMON WITH RESET

(71) Applicant: QUALCOMM MEMS Technologies, Inc., San Diego, CA (US)

(72) Inventors: Wilhelmus Johannes Robertus Van Lier, San Diego, CA (US); Edward Keat Leem Chan, San Diego, CA (US); Cheonhong Kim, San Diego, CA (US); Bing Wen, Poway, CA (US)

(21) Appl. No.: 14/500,321

(22) Filed: Sep. 29, 2014

Related U.S. Application Data
(60) Provisional application No. 62/005,615, filed on May 30, 2014.

(51) Int. Cl. G09G 3/34

(52) U.S. Cl. CPC G09G 3/3466; G09G 2310/06; G09G 2300/0809; G09G 2300/0421

(57) ABSTRACT

A display apparatus comprising an array of electromechanical display elements and a driver circuit coupled to the array is provided. The driver circuit is configured to apply a DC voltage to a first stationary electrode of the display element and adjust a bias voltage applied to a second stationary electrode of the display element from a first bias voltage to a second bias voltage before a reset period. The driver circuit is further configured to apply a first reset voltage to a movable electrode of the display element during the reset period, apply a write voltage to the movable electrode during a charging period to charge the movable electrode with a charge Q defined at least in part by the write voltage, and adjust the bias voltage applied to the second stationary electrode from the second bias voltage to a third bias voltage during a bias period.

### CLAIM OF PRIORITY UNDER 35 U.S.C. §119

The present application for patent claims priority to Provisional Application No. 62/005,615 entitled “SYSTEMS, DEVICES, AND METHODS FOR DRIVING AN ANALOG INTERFEROMETRIC MODULATOR UTILIZING DC COMMON WITH RESET” filed May 30, 2014, and assigned to the assignee hereof. Provisional Application No. 62/005,615 is hereby expressly incorporated by reference herein.

### TECHNICAL FIELD

This disclosure relates to devices and driving schemes for analog interferometric modulators and other display systems.

### BACKGROUND

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method of writing image data to an electromechanical display element to place the electromechanical display element into a defined display state. The method comprises applying a DC voltage to a first stationary electrode of the electromechanical display element. The method further comprises adjusting a bias voltage applied to a second stationary electrode of the electromechanical display element from a first bias voltage to a second bias voltage before a reset period. The method further comprises applying a first reset voltage to a movable electrode of the electromechanical display element during the reset period. The method further comprises applying a write voltage to the movable electrode during a charging period to charge the movable electrode with a charge Q defined at least in part by the write voltage. The method further comprises adjusting the bias voltage applied to the second stationary electrode from the second bias voltage to a third bias voltage during a bias period.

Another innovative aspect of the subject matter described in this disclosure can be implemented in a display apparatus. The display apparatus may include an array of electromechanical display elements, each electromechanical display element including at least one stationary electrode and a movable electrode. A driver circuit may be coupled to the array and configured to apply a DC voltage to a first stationary electrode of the electromechanical display element, adjust a bias voltage applied to a second stationary electrode of the electromechanical display element from a first bias voltage to a second bias voltage before a reset period, apply a first reset voltage to a movable electrode of the electromechanical display element during the reset period, apply a write voltage to the movable electrode during a charging period to charge the movable electrode with a charge Q defined at least in part by the write voltage and adjust the bias voltage applied to the second stationary electrode from the second bias voltage to a third bias voltage during a bias period.

Another innovative aspect of the subject matter described in this disclosure can also be implemented in a display apparatus. The display apparatus may include an array of electromechanical display elements, each electromechanical display element including at least one stationary electrode and a movable electrode. The display apparatus may also include means for applying a DC voltage to a first stationary electrode of the electromechanical display element, means for adjusting a bias voltage applied to a second stationary electrode of the electromechanical display element from a first bias voltage to a second bias voltage before a reset period, means for applying a first reset voltage to a movable electrode of the electromechanical display element during the reset period, means for applying a write voltage to the movable electrode during a charging period to charge the movable electrode with a charge Q defined at least in part by the write voltage, and means for adjusting the bias voltage applied to the second stationary electrode from the second bias voltage to a third bias voltage during a bias period.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following FIGS. may not be drawn to scale.

### BRIEF DESCRIPTION OF THE DRAWINGS

FIGS. 1A and 1B show examples of isometric views depicting a pixel of an interferometric modulator (IMOD) display device in two different states.

FIG. 2 shows a cross-section of an implementation of an analog interferometric modulator having two fixed layers and a movable third layer.

FIG. 3 shows an isometric view of two rows of an array of interferometric modulators according to one implementation.

FIG. 4 shows an overhead and an isometric view of an interferometric modulator and posts for use in a display element array.

FIG. 5 shows an example of a display element array illustrating, in plan view, a layout of interferometric modulators, black mask, scan lines, data lines, and locations of output vias.

FIG. 6 shows an example of a schematic circuit diagram illustrating a driving circuit array for a display device having the structure of FIG. 2.

FIG. 7 shows an example of a schematic circuit diagram illustrating a driving circuit for an array of interferometric modulators as shown in FIG. 6.

FIG. 8 is a timing diagram illustrating data and scan line signals and top and bottom electrode voltages that may be used to write data to display elements in the implementation of FIG. 7.

FIG. 9 is a timing diagram illustrating data and scan line signals and top and bottom electrode voltages that may be used to write data to display elements in the implementation of FIG. 7.

FIG. 10A is a system block diagram illustrating a display device that includes a plurality of IMOD display elements.

FIG. 10B is a system block diagram illustrating a display device that includes a plurality of IMOD display elements.

FIG. 11 is a flow chart showing the steps of an exemplary method or process that may be employed within the driving circuit arrangement of FIG. 6.

FIG. 12 is a functional block diagram of an exemplary device that may be employed in the driving circuit arrangement of FIG. 6.

FIG. 13 shows a chart illustrating an air gap between a fixed electrode and a movable electrode of an exemplary IMOD display element for given pulsed voltages at reset position and steady state voltages on the movable electrode.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the FIGS., but instead have wide applicability as will be readily apparent to one having ordinary skill in the art.

An active matrix display apparatus may include switch circuitry in addition to a display element at each pixel of a display array. In some implementations described herein, switch designs and layouts may implement an active matrix system for a display array using interferometric modulators. The layout may tightly place the circuitry at each display element to reduce the impact on fill factor. A black mask may be used to block visual detection of the circuitry at each display element.

Particular implementations of the subject matter described in this disclosure can be implemented to realize one or more of the following potential advantages. Implementations described herein provide drive schemes for accurate analog control of electromechanical display elements using relatively fast charge transfer to and from the display elements. Faster image frame writing is possible with such a charge controlled drive scheme over a voltage controlled drive scheme as no waiting for mechanical stabilization of the display element is needed. The implementations may produce nearly linear response of the display elements to deposited charge, while reducing the impact of common sources of error in electrode placement such as uncertainties in display element position during charge transfer. This error reduction may be accomplished by resetting the display element to a known state with a known capacitance. The drive scheme implementations also allow the use of a small number of drive transistors, with only one or two drive transistors per display elements being sufficient in many implementations. In some implementations, resetting display elements to a high capacitance position reduces power consumption by lowering drive voltages for transferring charge. Furthermore, when fixed charges are trapped on the display element, stiction control may be implemented by producing an electrostatic repelling force between portions of the display elements.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

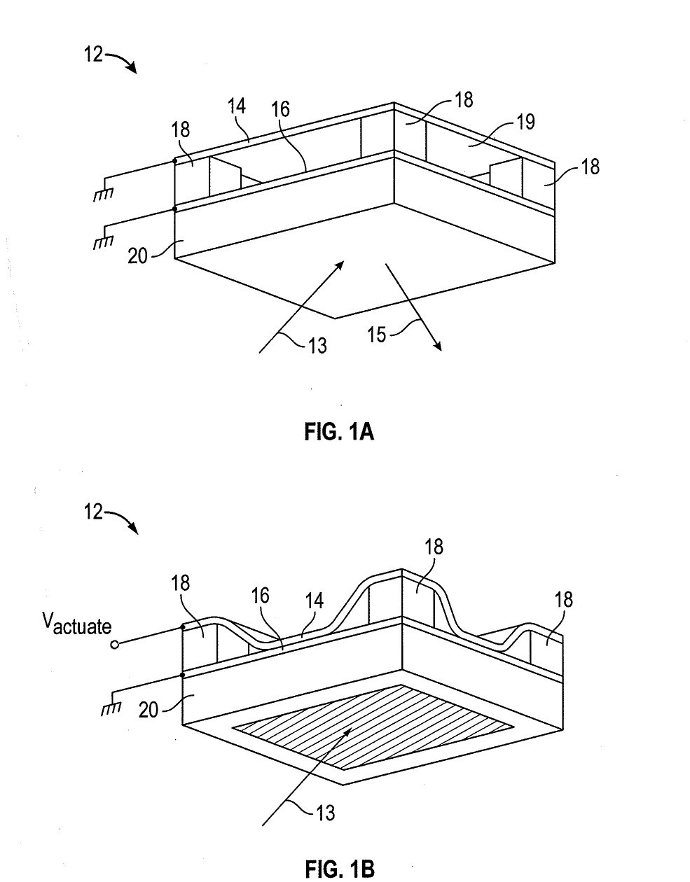

FIGS. 1A and 1B show examples of isometric views depicting a pixel of an interferometric modulator (IMOD) display device in two different states. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted pixels in FIGS. 1A and 1B depict two different states of an IMOD 12. In the IMOD 12 in FIG. 1A, a movable reflective layer 14 is illustrated in a relaxed position at a predetermined (e.g., designed) distance from an optical stack 16, which includes a partially reflective layer. Since no voltage is applied across the IMOD 12 in FIG. 1A, the movable reflective layer 14 remained in a relaxed or unactuated state. In the IMOD 12 in FIG. 1B, the movable reflective layer 14 is illustrated in an actuated position and adjacent, or nearly adjacent, to the optical stack 16. The voltage V_{actuate} applied across the IMOD 12 in FIG. 1B is sufficient to actuate the movable reflective layer 14 to an actuated position.

In FIGS. 1A and 1B, the reflective properties of pixels 12 are generally illustrated with arrows 13 indicating light incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixels 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, a highly conductive and reflective material, such as aluminum (Al), may be used for the movable reflective layer 14. The movable reflective layer 14 may be formed as a metal layer or layers deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be on the order of 1-1000 um, while the gap 19 may be on the order of <10,000 Angstroms (Å).

In some implementations, each pixel of the IMOD, whether in the actuated or relaxed state, is essentially a capacitor formed by the fixed and moving reflective layers. When no voltage is applied, the movable reflective layer 14a remains in a mechanically relaxed state, as illustrated by the pixel 12 in FIG. 1A, with the gap 19 between the movable reflective layer 14 and optical stack 16. However, when a potential difference, e.g., voltage, is applied to at least one of the movable reflective layer 14 and optical stack 16, the capacitor formed at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 in FIG. 1B. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

In some implementations, such as in a series or array of IMODs, the optical stacks 16 can serve as a common electrode that provides a common voltage to one side of the IMODs 12. The movable reflective layers 14 may be formed as an array of separate plates arranged in, for example, a matrix form. The separate plates can be supplied with voltage signals for driving the IMODs 12.

In implementations such as those shown in FIGS. 1A and 1B, the IMODs function as direct-view devices, in which images are viewed from the front side of the transparent substrate 20, i.e., the side opposite to that upon which the modulator is arranged. In these implementations, the back portions of the device can be configured and operated upon without impacting or negatively affecting the image quality of the display device, because the reflective layer 14 optically shields those portions of the device.

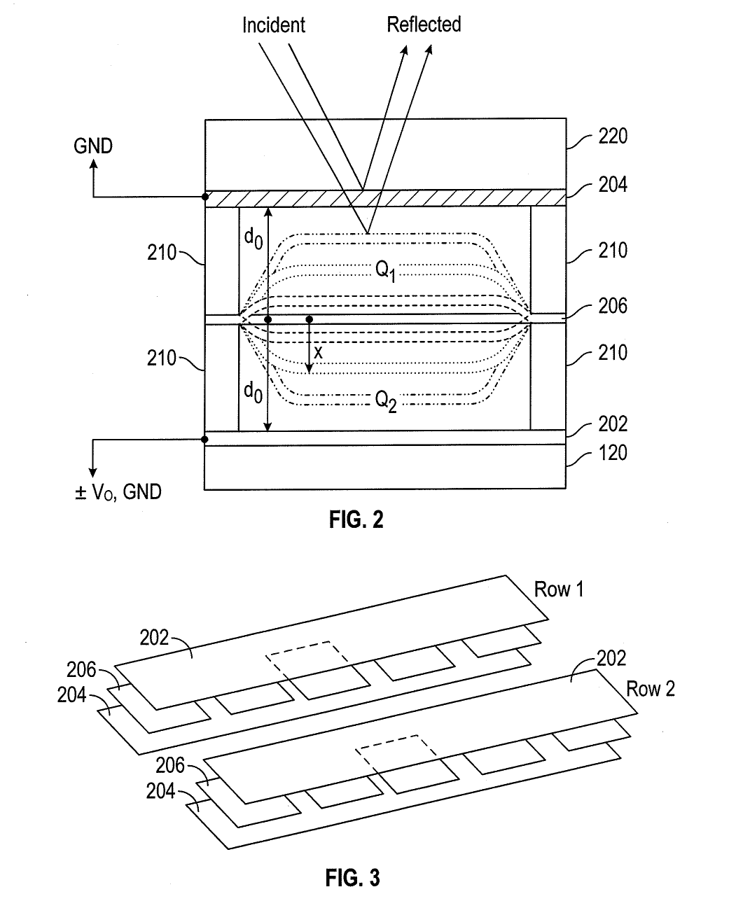

FIG. 2 shows a cross-section of an implementation of an interferometric modulator having two fixed layers and a movable third layer. Specifically, FIG. 2 shows an implementation of an analog interferometric modulator having a fixed first layer 202 (alternatively referred to as a stationary electrode, fixed conductive layer, or a top electrode), a fixed second layer 204 (alternatively referred to as a stationary electrode, fixed conductive layer, or a bottom electrode), and a movable third layer 206 (alternatively referred to as an image input electrode, movable conductive layer, or a movable electrode) positioned between the fixed first and second layers 202 and 204. Each of the layers 202, 204, and 206 may include an electrode or other conductive material. For example, the fixed first layer 202 may include a plate made of metal. Each of the layers 202, 204, and 206 may be stiffened using a stiffening layer formed on or deposited on the respective layer. In one implementation, the stiffening layer includes a dielectric. The stiffening layer may be used to keep the layer to which it is attached rigid and substantially flat. Some implementations of the interferometric modulator may be referred to as a three-terminal interferometric modulator. Certain of the implementations described herein may be implemented by omitting one of the top or bottom electrodes (e.g., fixed first layer 202 or fixed second layer 204).

In the implementation of FIG. 2, the three layers 202, 204, and 206 are electrically insulated by insulating posts 210. The movable third layer 206 is suspended from the insulating posts 210. The movable third layer 206 is configured to deform such that the movable third layer 206 may be displaced in a generally upward direction toward the fixed first layer 202, or may be displaced in a generally downward direction toward to the fixed second layer 204. In some implementations, the fixed first layer 202 may also be referred to as the top layer or top electrode. In some implementations, the fixed second layer 204 may also be referred to as the bottom layer or bottom electrode. The interferometric modulator 200 may be supported by a substrate 220.

In FIG. 2, the movable third layer 206 is illustrated as being in an equilibrium position with the solid lines. The equilibrium position is the position at which the movable layer comes to rest when no charge is on the movable layer and no voltage is applied to the top and bottom electrodes. In the specific implementation illustrated in FIG. 2, the equilibrium position of the middle layer is essentially centered between the top electrode and the bottom electrode, although this is not necessarily the case. As illustrated in FIG. 2 then, d₀ corresponds to the nominal distance between each fixed layer 202, 204 and the movable third layer 206 in the equilibrium state. The position of the movable third layer 206 from the equilibrium position between the fixed first layer 202 and fixed second layer 206 may be indicated by a value x, where a positive value of x corresponds to a position closer to the fixed first layer 202 and a negative value of x corresponds to a distance that is farther from the fixed first layer 202. When positioned at a substantial midpoint between the fixed first layer 202 and the fixed second layer 204, the position of the movable third layer 206 may correspond to a nominal position x₀. In some implementations, the device can be configured so that electrostatic forces will pull the electrode 206 away from the equilibrium position, and mechanical restoring forces will pull the electrode 206 toward the equilibrium position. The position x of the central layer 206 will be determined by a balance of these forces at any given time.

As illustrated in FIG. 2, a voltage difference may be applied between the fixed first layer 202 and the fixed second layer 204. In the implementation of FIG. 2, a voltage difference of V₀ is applied across the fixed layers, which may be applied in one specific example as a voltage of 0V or ground (GND) applied to the fixed second layer 204 and a voltage ±V₀ applied to the fixed first layer 202. If a fixed negative charge Q is present on the movable third layer 206, the movable third layer 206 will be electrostatically pulled toward fixed first layer 202 when the voltage applied to the fixed first layer 202 is +V₀ and will be pushed away from fixed first layer 202 when the voltage applied to the fixed first layer 202 is −V₀. Contrarily, if the charge Q on movable third layer 206 is positive, the movable third layer 206 will be electrostatically pulled toward or pushed away from the fixed first layer 202, depending on whether the voltage applied to the fixed first layer 202 is −V₀ or +V₀, respectively. If the charge Q is zero, the movable layer 206 will move to the equilibrium position, regardless of the magnitude of V₀.

The voltage difference V₀ between the fixed first and second layers 202 and 204 can vary widely depending on the materials and construction of the device, and in many implementations may be in the range of about 5-20 volts, more preferably between 6 to 10 V. As with the two layer device described above with reference to FIGS. 1A and 1B, the movable third layer 206 may include a mirror to reflect light entering the interferometric modulator through substrate 220. The mirror may include a metal material. The fixed second layer 204 may include a partially absorbing material such that the fixed second layer 204 acts as an absorbing layer. When light reflected from the movable third layer 206 is viewed from the side of the substrate 220, the viewer may perceive the reflected light as a certain color. By adjusting the position of the movable third layer 206, certain wavelengths of light may be selectively reflected.

FIG. 3 shows an isometric view of two rows of an array of interferometric modulators according to one implementation. In implementations according to FIG. 3, the top electrode 202 and the bottom electrode 204 may be formed as electrically conductive strips along each row. The bottom electrode 204 may be coupled to a DC voltage (e.g., ground or 0V) while the top electrode 202 may be coupled to an output of a driver bias circuit. In these implementations, the voltages applied to the top and bottom electrodes 202 and 204 along a row can be controlled by the driver along with the voltage applied to the movable electrode 206.

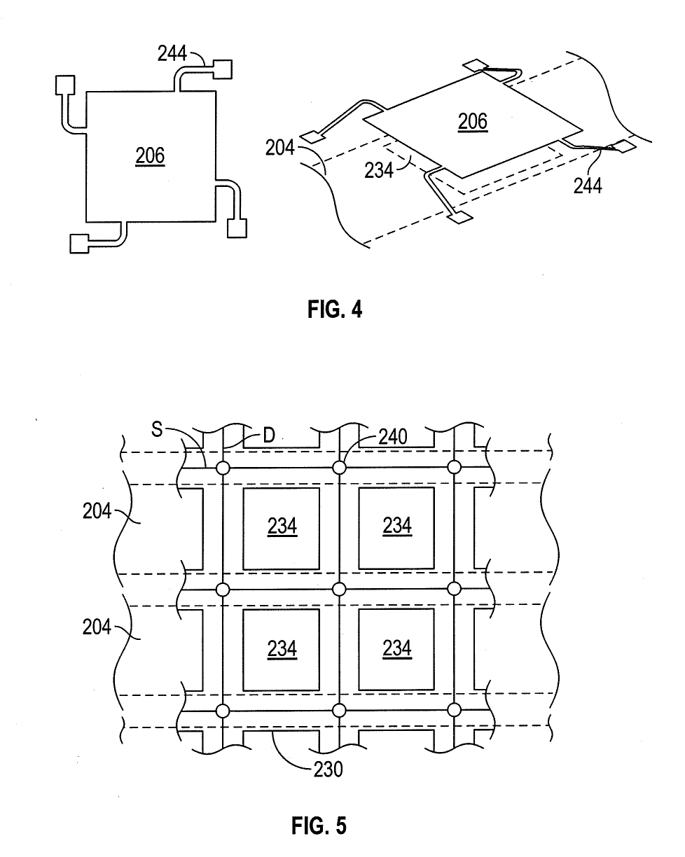

FIG. 4 shows an overhead and an isometric view of an interferometric modulator and posts for use in a display element array. The movable electrode 206 may be mechanically suspended over the stationary electrode and the substrate 220 on arms 244. The movable electrode 206 may be coupled to more than one arm, e.g., four arms as shown in FIG. 4. Mechanical suspension using four arms 244 or a symmetrical layout of arms 244 may increase the stability of the movable electrode 206. the arms are connected to the output via 240 over the black mask 230 at or near the intersection between a row line and a column line of the black mask 230. The arms 244 may be connected to the movable electrode 206 at a location that is not directly over the output via 240 along the z-axis. The arms 244 may therefore be at an angle between the plane of the substrate 220 and the z-axis.

In an implementation according to FIG. 4, the arms 244 may connect at the corners of the viewing areas 234. Although multiple arms 244 connected to center layers 206 of different display elements may all be mechanically coupled at a given output via 240, in some implementations, only one of the arms may be electrically connected to each output via 240. Strips of top electrode material 202 (not shown) may be suspended on posts (also not shown) above the center electrode layers 206 extending along rows similar to and aligned with the bottom electrodes 204 that are deposited on the substrate, although it will be appreciated that the top electrodes need not be partially reflective as are the bottom electrodes 202, and can be made instead with a thicker metal layer of aluminum or other metal.

FIG. 5 shows an example of a display element array illustrating, in plan view, a layout of interferometric modulators, black mask, scan lines, data lines, and locations of output vias. As illustrated in FIG. 5, a black mask grid 230 can be deposited on substrate 220. This grid defines viewing areas 234. The black mask may be deposited in a grid with row lines and orthogonal column lines. In other implementations, the row and column lines may be substantially orthogonal or may not be orthogonal, e.g., the column lines may be at an angle from the row lines, e.g., 30 degrees from the perpendicular. The black mask may be formed from a thin partially reflecting metal layer and a thicker fully reflective layer separated by a thin dielectric. This can produce destructive interference of reflected light, producing a dark visual area where the black mask is deposited when viewing the substrate, according to the same principles described above with reference to FIG. 1B. This black mask 230 may be covered with an insulator, and data lines and scan lines deposited on top of the black mask 230. Also on top of the black mask 230 are the driving transistors (illustrated further below) which may have output vias 240 that connect to the center layer 206 of each display element. The bottom electrodes 204 may be deposited over the black mask 230, data lines, scan lines, and thin film transistors in strips along rows of viewing areas 234.

In the arrays of FIG. 5, a black mask is first deposited on a substrate, followed by drive lines and transistors, followed by MEMS display element layers. The black mask 230 may be a black or opaque coating and may be applied by deposition, etching, lithography, and/or other micromachining processes. The black mask 230 layer be formed or patterned to block all light or to block certain wavelengths of light in certain directions. Other implementations for forming the black mask and circuitry layers are possible. For example, the thin film transistors and drive lines may be deposited last, on top of the MEMS display element layers. In another implementation, the thin film transistors can be deposited on the underside of a back plate that is positioned above the MEMS display element layers. In yet another alternative implementation, the thin film transistors and drive lines can be formed on the substrate first, under the black mask and the MEMS display elements, and the device can be viewed through a transparent backplate provided above the deposited MEMS display element layers.

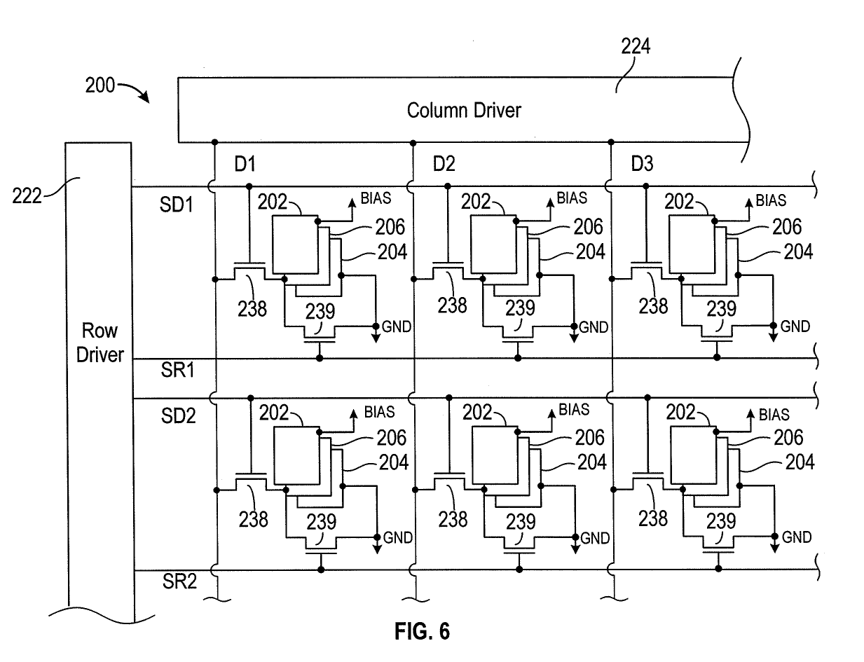

FIG. 6 shows an example of a schematic circuit diagram 200 illustrating a driving circuit array for a display device having the structure of FIG. 2. The driving circuit array 200 can be used for implementing an active matrix addressing scheme for providing image data to display elements of a display array assembly. The driving circuit 200 includes a column driver 224, a row driver 222, first to m-th data lines D₁-Dₘ, first to n-th scan lines SD₁-Sₙ, first to p-th reset lines SR₁-SRₙ, and an array of switches or switching circuits 238/239. Each of the data lines D₁-Dₘ extends from the column driver 224, and is electrically connected to a first terminal of respective columns of switches 238. Each of the scan lines SD₁-Sₙ extends from the row driver 222, and is electrically connected to a gate of each switch in respective rows of switches 238. The switches 238 are electrically coupled between one of the data lines D₁-Dₘ and the movable third layer 206 of a respective one of the display elements and receive a switching control signal from the row driver 222 via one of the scan lines SD₁-Sₙ. Each of the reset lines SR₁-SRₚ extends from the row driver 222, and is electrically connected to a gate of respective columns of switches 239. The switches 239 are electrically coupled between the movable third layer 206 of a respective one of the display elements and a predefined DC common voltage (e.g., 0V or GND). The fixed first layer 202 may be coupled to a bias voltage which may have one of several values depending on the time or mode of operation of the driving circuit 200, e.g., a voltage of +6 to +10V, 0V (GND) or −6 to −10V. The fixed second layer 204 may be coupled to a predetermined DC voltage, e.g., 0V or GND.

The column driver 224 can receive image data from outside the display and can provide the image data on a row by row basis in a form of voltage signals to the switches 238 via the data lines D1-Dm. The row driver 222 can select a particular row of the display elements by turning on the switches 238 associated with the selected row of display elements. When the switches 238 in the selected row are turned on, the image data from the column driver 224 is passed to the selected row of the display elements. Contrarily, when the switches 239 in the selected row are turned on, the image data previously stored on the movable third layer 206 of the respective display element may be erased by passing the stored charge on movable third layer 206 to ground via the switch 239.

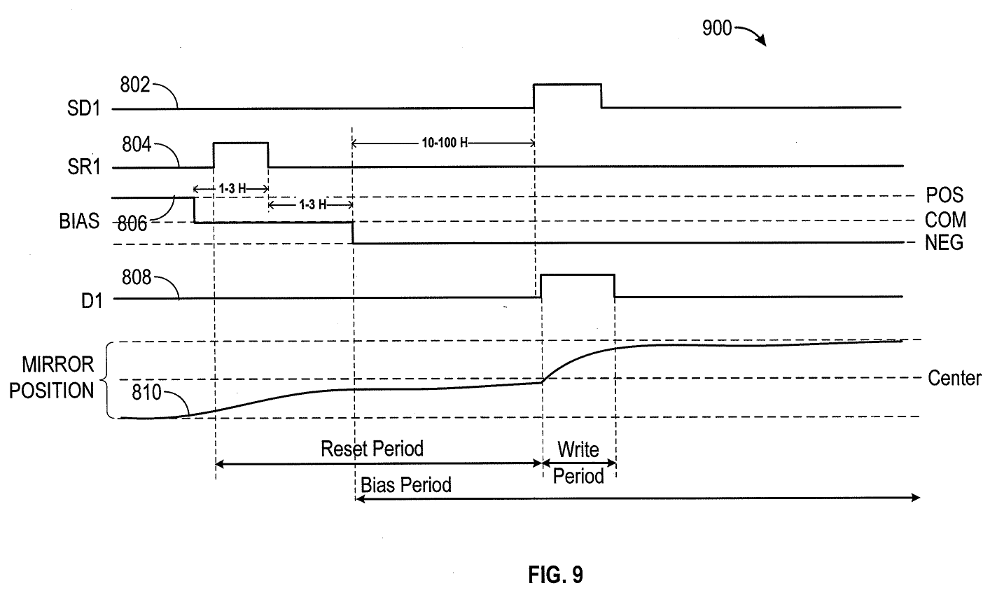

During operation, the BIAS voltage may be switched from a previous value, e.g., either a positive 6 to 10 V or a negative 6 to 10 V to 0V or GND. Once the BIAS voltage has been reduced to 0V or GND, the reset line (e.g., SR₁, SR₂, SR₃) corresponding to the currently selected pixel may be enabled to turn on switch 239 and to provide a first reset pulse. This will cause any previously held charge on the movable third layer 239 to flow to ground. The reset line corresponding to the currently selected pixel may then be disabled, turning off switch 239. In some implementations, the reset line (e.g., SR1, SR2, SR3) corresponding to the currently selected pixel may be enabled again to turn on switch 239 and to provide a second reset pulse before adjusting the BIAS voltage from 0V. This second reset pulse may ensure a complete and repeatable discharge of the movable third layer 206, as some level of “kickback” charge may remain or be reintroduced to the movable third layer 206 after the BIAS voltage has been transitioned to 0V. In some implementations, the BIAS voltage may then be toggled from the 0V or GND to the opposite voltage range from which it was immediately previously brought to 0V or GND, e.g., if BIAS was positive 6 to 10 V before being brought to 0V GND, BIAS is now brought to negative 6 to 10 V and vice versa. The data line (D₁-Dₘ) corresponding to the selected pixel may then be driven with the 0-5.5V based on the image color information to be displayed on the pixel. The scan line (SD₁-SDₙ) corresponding to the selected pixel may then be driven high in order to close the switch 238, allowing the movable third layer 206 to be charged by the voltage provided by the corresponding data line (D₁-Dₘ). This implementation may be explained in more detail in connection with FIG. 9.

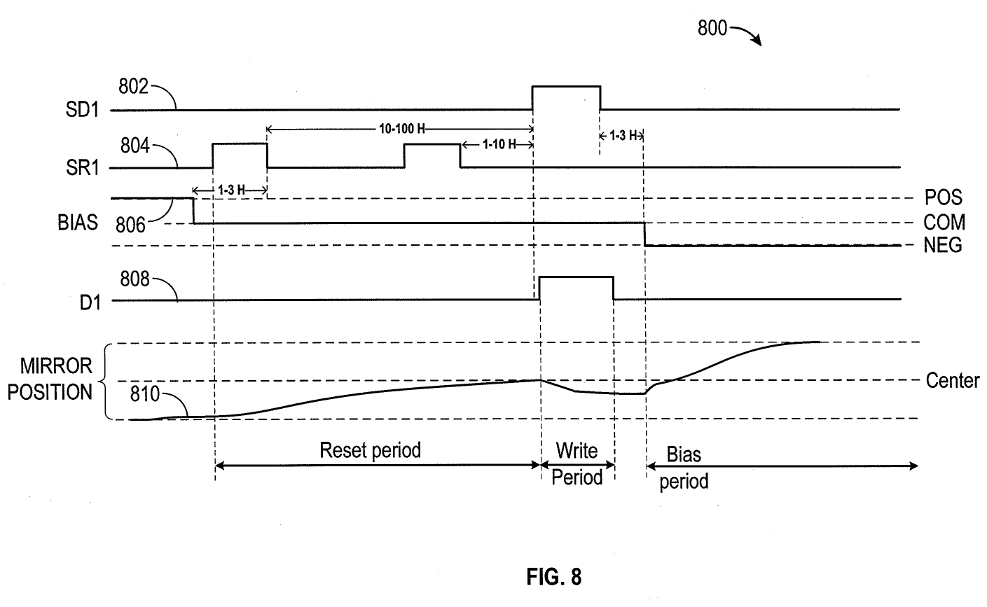

In some other implementations the BIAS voltage is held at 0V or GND until after the data has been written onto the movable third layer 206, after which the BIAS voltage is then toggled to the positive or negative voltage opposite of what it was before being adjusted to 0V or GND, as described above. This implementation may be explained in more detail in connection with FIG. 8. Thus, after proceeding through each row and column of pixels, the pixels that had e.g., 0-5.5 volts applied may display or reflect light of a particular color corresponding to the voltage applied (e.g., the movable third layer 206 of those pixels will be deflected in proportion to the charge stored thereon, thereby adjusting the interference pattern between the light reflecting off of the surface of the pixel and the light reflecting off of the movable third layer 206). The pixels that had 0-volts applied will be black. The display elements or pixels will hold the image data because the charge on the actuated pixels will be retained when both the switches 238 and 239 are off, except for some leakage through insulators and the off state switch. Generally, this leakage is low enough to retain the image data on the display elements until another set of data is written to the row. These steps can be repeated to each succeeding row until all of the rows have been selected and image data has been provided thereto.

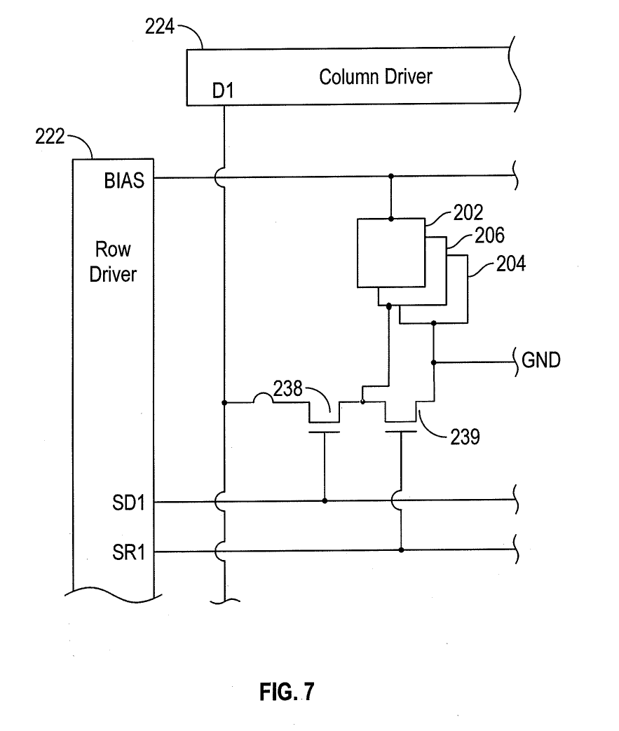

FIG. 7 shows an example of a schematic circuit diagram illustrating a driving circuit for an array of interferometric modulators as shown in FIG. 6. FIG. 7 shows one display element in a display array. The display element includes two stationary electrodes, e.g. a top electrode 202 and a bottom electrode 204 and an image input electrode, e.g. movable electrode 206. The top electrode 202 may be in communication with a row driver circuit 222, where the communication is represented by electrical connection in the circuit to BIAS, as previously described in connection with FIG. 6. The bottom electrode 204 may be connected to a predetermined DC voltage, e.g., 0V or GND. The display element in this implementation further includes two associated drive transistors. The source electrode of the first drive transistor 238, or the write drive transistor, may be connected to a data line D₁ driven by column driver 224. The gate electrode of the first drive transistor 238 may be connected to a scan line SD₁ driven by row driver 222. The drain electrode of the first drive transistor 238 may be connected to the movable electrode 206. The source electrode of the second drive transistor 239, or the reset drive transistor, may be connected between the movable electrode 206 (source) and the predetermined DC voltage (drain), e.g., 0V or ground. The gate electrode of the second drive transistor 239 may be connected to a scan reset line SR₁ driven by row driver 222.

The drive transistor 238 may be used to connect a data write voltage applied to data line D₁ to the movable electrode 206 when scan line SD₁ is asserted during a writing period. The write data voltage may apply variable charge Q to the movable electrode 206. The drive transistor 239 may be used to connect the movable electrode 206 to the predetermined common DC voltage, e.g., 0V or GND, when scan reset line SR₁ is asserted during a reset period. In some implementations, the reset lines for all the columns of the array may be ganged together and tied to ground or another suitable voltage level. A voltage V₀ may be applied between the top electrode 202 and bottom electrode 204 during a bias period, as previously described in connection with FIG. 6 and as will be further described in connection with FIGS. 8 and 9 below.

FIGS. 8 and 9 are timing diagrams illustrating data and scan line signals and top and bottom electrode voltages that may be used to write data to display elements in the two transistor implementation of FIG. 7.

FIG. 8 is a timing diagram 800 illustrating data and scan line signals and top and bottom electrode voltages that may be used to write data to display elements in the implementation of FIG. 7, or the like. During a “reset period,” a bias voltage previously applied to the top electrode 202 via the BIAS line 806 may be brought to ground voltage (e.g., 0V). Once the BIAS line 806 has been brought to ground, the reset line SR₁ 804 may be driven high. As previously described, the reset line SR₁ 804 may be connected to the gate of switch 239 of FIG. 6. When the SR₁ reset line is driven high the switch 239 may be closed connecting the movable electrode 206 to the DC common voltage (e.g., ground or 0V), thereby allowing any charge on the movable electrode 206 to flow to ground. This first asserted period may comprise a first reset pulse. The interval of time between the BIAS line 806 being brought to ground and de-asserting the reset line SR₁ 804 for the first reset pulse may be substantially equal to approximately 1-3 row times (e.g., 1-3 times the amount of time it takes for one row of pixels to be written). This duration allows ample time for the movable electrode 206 to reset to the centered equilibrium position, as can be seen by the mirror position 810, which begins to move towards the center position after BIAS line 806 and reset line SR₁ 804 are adjusted. As previously described in connection with FIG. 6, in some implementations, in order to ensure repeatable removal of substantially all charge on the movable electrode 206, a second reset pulse may be asserted after the first reset pulse but before asserting the write control line SD₁. Utilizing the second reset pulse may counteract any effect of a “kickback charge” remaining or induced on the movable electrode 206. In some implementations, the interval of time between de-asserting the reset line SR₁ 804 for the second reset pulse and subsequently asserting the write control line SD₁ may be substantially equal to approximately 1-10 row times. As previously described, the bottom electrode 206 may be connected to the DC common voltage (e.g., 0V or GND) at all times. Once the movable electrode 206 has reset to the center equilibrium position, the write control line SD₁ 802 may be asserted, which may close the switch 238 and connect the data line D1 808 to the movable electrode 206. In some implementations, the write control line SD1 802 may be asserted approximately 10-100 row times after the reset line 804 is de-asserted. The data line D1 808 may then be asserted with a voltage proportional to the desired deflection position of the movable electrode 206 after the writing operation. This may delineate a writing interval. Charge will accumulate on the movable electrode 206 in proportion to the voltage asserted on data line D₁ 808. The voltage applied to data line D₁ 808 is selected to place this charge on the movable electrode according the formula V_{D1}=Q/2C₀, since there are two capacitors of known capacitance C₀ connected between the movable electrode 206 and the top and bottom electrodes 202 and 204 when V_{D1} is applied. This charging period can be relatively fast compared to the mechanical response time of the movable layer 206, so that if this charging time is limited, any position changes to the movable electrode 206 may also be limited as this charge is applied. This is one advantage of performing the charging period while the top electrode and bottom electrode are held at zero volts, rather than performing the charging with these electrodes at their bias voltages. After charge Q is applied, the voltage on scan line SD₁ may be returned to a gate off voltage, switching off the drive transistor 238.

Once the write control line SD₁ 802 and the data line D₁ 808 have been de-asserted, the BIAS line 806 may be adjusted from the DC common voltage (e.g., 0V or GND) to a BIAS voltage opposite of what it was before being adjusted to common (e.g., as shown, BIAS line 806 is adjusted from the positive voltage to common, and then to a negative voltage substantially equal in magnitude but opposite in sign from the positive voltage). In some implementations, the BIAS line 806 may be adjusted to the negative voltage approximately 1-3 row times after de-asserting the write control line SD₁ 802. As shown, once the BIAS line 806 has been adjusted to the negative voltage the movable electrode 206 may begin to move toward its desired final written position. In this way, the charge Q for each display element along the row is determined based on the desired final state of the movable electrode 206 after the write procedure is complete and the BIAS line 806 has been toggled to the opposite voltage from the last write phase of the particular pixel.

As noted above, it is advantageous to apply this voltage after the charging period is complete to reduce any premature motion of the movable electrode 206 during the charging period. Another advantage to maintaining the top and bottom electrodes at zero voltage during the charging period rather than maintaining them at the bias voltage is that it provides a stepwise transition through zero when alternating which stationary electrode is at a higher relative voltage. This polarity switching between write cycles as illustrated in FIG. 8 is advantageous for reducing charge buildup on the devices.

It may be noted that the reset period is longer than the write period in the current example. Although the electrical response of the display element is fast, the longer time period of reset period allows the display element to mechanically move from its prior position (set there in accordance with image data from the previous frame) to the reset equilibrium position, which takes a longer time period than the actual charge transfer resulting from applied voltages to the electrodes. In this implementation, the reset phase for any given row can be pipelined with the charge and bias periods of other rows such that when one row is being reset, other rows may be charged and biased.

FIG. 9 is a timing diagram 900 illustrating data and scan line signals and top and bottom electrode voltages that may be used to write data to display elements in the implementation of FIG. 7, or the like. The timing diagram 900 may be the same as timing diagram 800 of FIG. 8 with the exception that rather than toggling the BIAS line 806 after the write action has been completed, the BIAS line 806 is adjusted from the positive voltage to the common voltage (e.g., 0V or GND) before the reset operation. The BIAS line may then be toggled from the common voltage to the negative voltage having substantially equal magnitude but opposite sign as the previous positive voltage after the reset operation(s) but before the write operation. Although not shown in FIG. 9, some implementations contemplate the use of both of the first reset pulse and the second reset pulse on the SR₁ line, as previously described in connection with FIG. 8 in order to ensure repeatable, substantially complete discharging of the movable electrode 206. As shown, the BIAS line 806 may be toggled to the negative voltage approximately 1-3 row times after the reset line SR1 804 has been de-asserted. Such an operation may allow the movable electrode 206 to move to the centered equilibrium state faster than the implementation of FIG. 8, as shown by the mirror position 810.

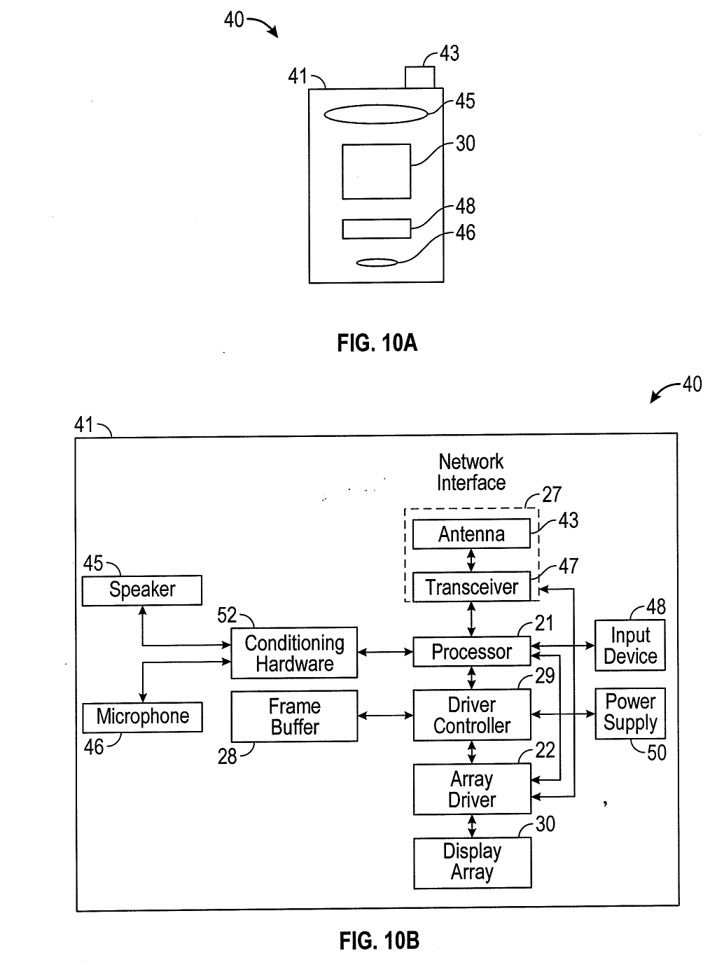

FIGS. 10A and 10B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 10A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 10A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 202.11 standard, including IEEE 202.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data. GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable displays array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

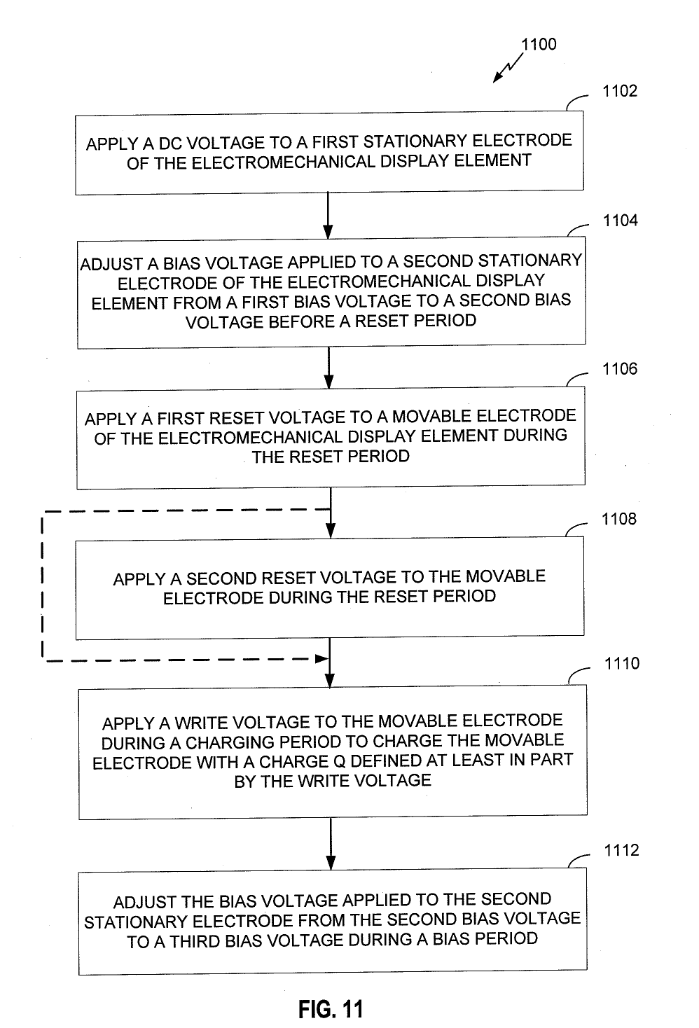

FIG. 11 is a flow chart 1100 showing the steps of an exemplary method or process that may be employed within the driving circuit arrangement of FIG. 6. Although the illustrated method 1100 is described herein with reference to a particular order, in various implementations, blocks herein may be performed in a different order, or omitted, and additional blocks may be added.

Block 1102 may include applying a DC voltage to a first stationary electrode of the electromechanical display element. As previously described in connection with FIGS. 6 and 7, the DC voltage may be approximately 0V or GND and may be applied to the stationary electrode 204. The method may advance to block 1104.

Block 1104 may include adjusting a bias voltage applied to a second stationary electrode of the electromechanical display element from a first bias voltage to a second bias voltage before a reset period. As previously described in connection with FIGS. 6 and 7, the bias voltage may be applied to the stationary electrode 202 and may be approximately +6 to +10 V, adjusted to approximately 0V or GND. The method may advance to block 1106.

Block 1106 may include applying a first reset voltage to a movable electrode of the electromechanical display element during the reset period. As previously described in connection with FIGS. 6 and 7, the reset voltage may be approximately 0V or GND applied to the movable electrode 206. The method may advance to block 1108 where a first reset voltage pulse and a second reset voltage pulse are utilized, for example. In another example, the method may bypass block 1108 and proceed to block 1110 where only the first reset voltage pulse is utilized.

Block 1108 may include applying a second reset voltage to the movable electrode during the reset period. As previously described in connection with FIGS. 6 and 7, the reset voltage may be approximately 0V or GND applied to the movable electrode 206. The method may advance to block 1110.

Block 1110 may include applying a write voltage to the movable electrode during a charging period to charge the movable electrode with a charge Q defined at least in part by the write voltage. As previously described in connection with FIGS. 6 and 7, the write voltage may be proportional to the desired deflection of the movable electrode 206.

Block 1112 may include adjusting the bias voltage applied to the second stationary electrode from the second bias voltage to a third bias voltage during a bias period. As previously described in connection with FIGS. 6 and 7, the first bias voltage and the third bias voltage may be equal in magnitude and opposite in polarity. For example, the first bias voltage may be +6 to +10 V, while the third bias voltage may be −6 to −10 V, the second bias voltage being approximately 0V or GND.

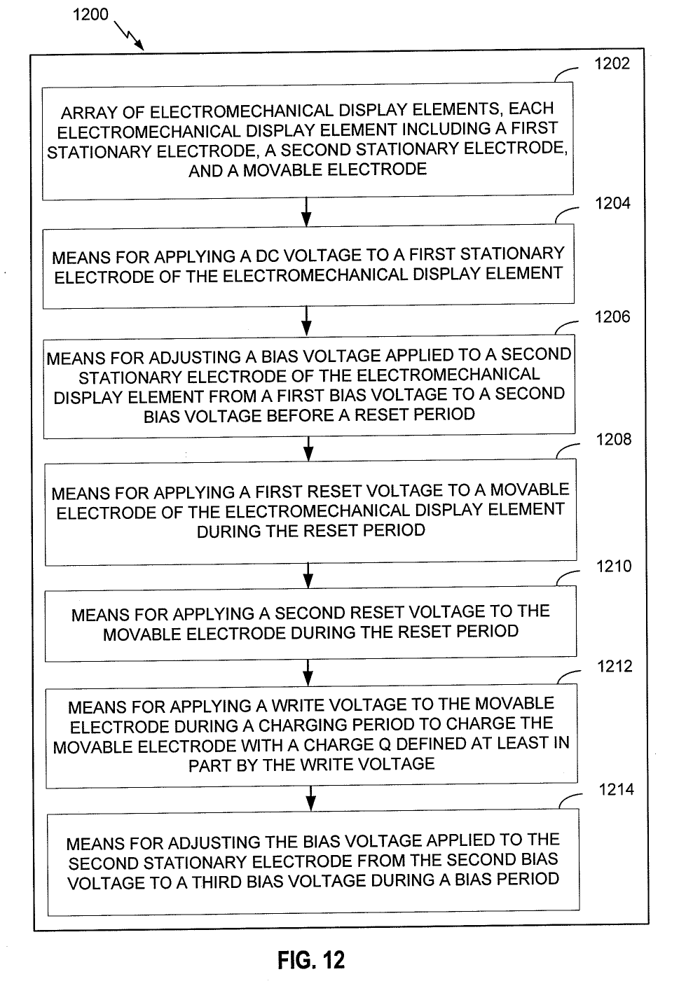

FIG. 12 is a functional block diagram of an exemplary device that may be employed in the driving circuit arrangement of FIG. 6. The device 1200 includes an array 1202 of electromechanical display elements, each electromechanical display element including a first stationary electrode, a second stationary electrode, and a movable electrode.

The device 1200 includes means 1204 for applying a DC voltage to a first stationary electrode of the electromechanical display element. In an implementation, means 1204 may be configured to perform one or more of the functions discussed above with respect to block 1102 of FIG. 11. In an implementation, the means 1204 may include one or both of the column driver 224 or row driver 222 of FIG. 6, for example.

The device 1200 includes means 1206 for adjusting a bias voltage applied to a second stationary electrode of the electromechanical display element from a first bias voltage to a second bias voltage before a reset period. In an implementation, means 1206 may be configured to perform one or more of the functions discussed above with respect to block 1104 of FIG. 11. In an implementation, the means 1206 may include one or both of the column driver 224 or row driver 222 of FIG. 6, for example.

The device 1200 includes means 1208 for applying a first reset voltage to a movable electrode of the electromechanical display element during the reset period. In an implementation, means 1208 may be configured to perform one or more of the functions discussed above with respect to block 1106 of FIG. 11. In an implementation, the means 1208 may include one or both of the column driver 224 or row driver 222 of FIG. 6, for example.

The device 1200 includes means 1210 for applying a second reset voltage to the movable electrode during the reset period. In an implementation, means 1210 may be configured to perform one or more of the functions discussed above with respect to block 1108 of FIG. 11. In an implementation, the means 1210 may include one or both of the column driver 224 or row driver 222 of FIG. 6, for example.

The device 1200 includes means 1212 for applying a write voltage to the movable electrode during a charging period to charge the movable electrode with a charge Q defined at least in part by the write voltage. In an implementation, means 1212 may be configured to perform one or more of the functions discussed above with respect to block 1110 of FIG. 11. In an implementation, the means 1212 may include one or both of the column driver 224 or row driver 222 of FIG. 6, for example.

The device 1200 includes means 1214 for means for adjusting the bias voltage applied to the second stationary electrode from the second bias voltage to a third bias voltage during a bias period. In an implementation, means 1214 may be configured to perform one or more of the functions discussed above with respect to block 1112 of FIG. 11. In an implementation, the means 1214 may include one or both of the column driver 224 or row driver 222 of FIG. 6, for example.

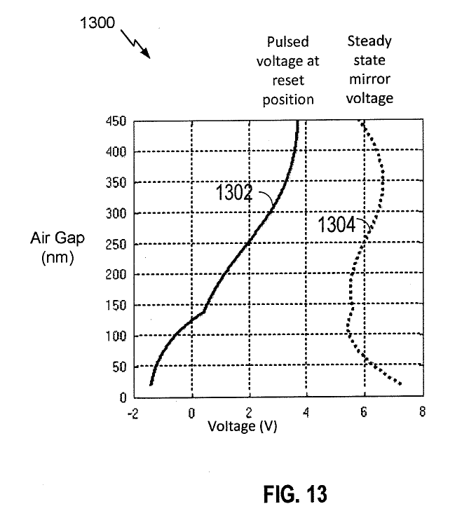

FIG. 13 shows a chart 1300 illustrating an air gap between a fixed electrode and a movable electrode of an exemplary IMOD display element for given pulsed voltages at reset position and steady state voltages on the movable electrode. As shown, the pulsed voltage line 1302 may indicate the air gap between a fixed or stationary electrode and the movable electrode of the IMOD display element for each voltage that the movable electrode is subjected to when it is at the reset position midway between the first and second stationary electrodes. In addition, the steady state movable electrode voltage line 1304 may indicate the air gap between the fixed or stationary electrode and the movable electrode of the IMOD display element for each voltage that the movable electrode is subjected to once the movable electrode has settled to a stationary position.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the FIGS., and indicate relative positions corresponding to the orientation of the FIG. on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method of writing image data to an electromechanical display element including a first stationary electrode, a second stationary electrode, and a movable electrode, the method comprising:
applying a direct current (DC) voltage to the first stationary electrode of the electromechanical display element;
adjusting a bias voltage applied to the second stationary electrode of the electromechanical display element from a first bias voltage to a second bias voltage before a reset period;
applying a first reset voltage to the movable electrode of the electromechanical display element during the reset period;
applying a write voltage to the movable electrode during a charging period to charge the movable electrode with a charge Q defined at least in part by the write voltage; and
adjusting the bias voltage applied to the second stationary electrode from the second bias voltage to a third bias voltage during a bias period.

2. The method of claim 1, further comprising applying a second reset voltage to the movable electrode during the reset period.

3. The method of claim 2, wherein the applied second reset voltage is deasserted a first amount of time before the charging period, the first amount of time equal to approximately 1 to 10 times a period to write an entire row of electromechanical display elements.

4. The method of claim 1, wherein adjusting the bias voltage from the second bias voltage to the third bias voltage occurs before the charging period.

5. The method of claim 1, wherein adjusting the bias voltage from the second bias voltage to the third bias voltage occurs after the charging period.

6. The method of claim 1, wherein the DC voltage, the reset voltage, and the second bias voltage are substantially zero volts.

7. The method of claim 1, wherein the first bias voltage and the third bias voltage are substantially equal in magnitude and opposite in polarity.

8. The method of claim 1, wherein during the reset period, the movable electrode is placed in a reset state.

9. The method of claim 1, wherein the charging period occurs a second amount of time after the reset period, the second amount of time equal to approximately 10 to 100 times a period to write an entire row of electromechanical display elements.

10. A display apparatus comprising:
an array of electromechanical display elements, each electromechanical display element including a first stationary electrode, a second stationary electrode, and a movable electrode;
a driver circuit coupled to the array and configured to:
apply a DC voltage to the first stationary electrode of the electromechanical display element;
adjust a bias voltage applied to the second stationary electrode of the electromechanical display element from a first bias voltage to a second bias voltage before a reset period;
apply a first reset voltage to the movable electrode of the electromechanical display element during the reset period;
apply a write voltage to the movable electrode during a charging period to charge the movable electrode with a charge Q defined at least in part by the write voltage; and
adjust the bias voltage applied to the second stationary electrode from the second bias voltage to a third bias voltage during a bias period.

11. The display apparatus of claim 10, wherein the driver circuit is further configured to apply a second reset voltage to the movable electrode during the reset period.

12. The display apparatus of claim 11, wherein the driver circuit is further configured to deassert the applied second reset voltage a first amount of time before the charging period, the first amount of time equal to approximately 1 to 10 times a period to write an entire row of electromechanical display elements.

13. The display apparatus of claim 10, wherein the driver circuit is configured to adjust the bias voltage from the second bias voltage to the third bias voltage before the charging period.

14. The display apparatus of claim 10, wherein the driver circuit is configured to adjust the bias voltage from the second bias voltage to the third bias voltage after the charging period.

15. The display apparatus of claim 10, wherein the DC voltage, the reset voltage, and the second bias voltage are substantially zero volts.

16. The display apparatus of claim 10, wherein the first bias voltage and the third bias voltage are substantially equal in magnitude and opposite in polarity.

17. The display apparatus of claim 10, wherein the movable electrode is positioned between the first and second stationary electrodes.

18. The display apparatus of claim 10, wherein during the reset period, the driver circuit is configured to place the movable electrode in a reset state.

19. The display apparatus of claim 10, wherein the driver circuit is configured to perform the charging period a second amount of time after the reset period, the second amount of time equal to approximately 10 to 100 times a period to write an entire row of electromechanical display elements.

20. A display apparatus comprising:
an array of electromechanical display elements, each electromechanical display element including a first stationary electrode, a second stationary electrode, and a movable electrode;
means for applying a DC voltage to the first stationary electrode of the electromechanical display element;
means for adjusting a bias voltage applied to the second stationary electrode of the electromechanical display element from a first bias voltage to a second bias voltage before a reset period;
means for applying a first reset voltage to the movable electrode of the electromechanical display element during the reset period;
means for applying a write voltage to the movable electrode during a charging period to charge the movable electrode with a charge Q defined at least in part by the write voltage; and
means for adjusting the bias voltage applied to the second stationary electrode from the second bias voltage to a third bias voltage during a bias period.

21. The display apparatus of claim 20, further comprising means for applying a second reset voltage to the movable electrode during the reset period.

22. The display apparatus of claim 21, wherein the means for applying the second reset voltage is configured to deassert the applied second reset voltage a first amount of time before the charging period, the first amount of time equal to approximately 1 to 10 times a period to write an entire row of electromechanical display elements.

23. The display apparatus of claim 20, wherein the means for adjusting the bias voltage from a first bias voltage to a second bias voltage is configured to adjust before the charging period.

24. The display apparatus of claim 20, wherein the means for adjusting the bias voltage from a first bias voltage to a second bias voltage is configured to adjust after the charging period.

25. The display apparatus of claim 20, wherein the DC voltage, the reset voltage, and the second bias voltage are substantially zero volts.
